(19) United States
(12) Patent Application Publication
(10) Pub. No.: US 2026/0265059 A1
(43) Pub. Date: Sep. 10, 2026

(54) STIRRING SYSTEM FOR LITHIUM IRON PHOSPHATE SLURRY

(71) Applicant: Hoosun Technology Group Co., Ltd., Guizhou (CN)

(72) Inventors: Yuanlin LI, Shanghai (CN); Legui QIN, Shanghai (CN)

(73) Assignee: Hoosun Technology Group Co., Ltd., Guizhou (CN)

(21) Appl. No.: 19/661,553

(22) Filed: Apr. 28, 2026

Related U.S. Application Data
(63) Continuation of application No. PCT/CN2024/102859, filed on Jul. 1, 2024.

(30) Foreign Application Priority Data
Nov. 1, 2023 (CN) 202311433807.X

(51) Int. Cl. C01B 25/45; B01F 23/50; B01F 23/53; B01F 35/22; B01F 35/71

(52) U.S. Cl. CPC C01B 25/45; B01F 23/53; B01F 23/58; B01F 35/2205; B01F 35/711; B01F 35/712

(57) ABSTRACT

The present application provides a stirring system for lithium iron phosphate slurry, including a first dispersion system formed by a first feeding mechanism, a second feeding mechanism, a first stirring tank, a homogenization pump, and a first demagnetizing machine, and a second dispersion system formed by a second stirring tank, a driving pump, a second demagnetizing machine, a heat exchanger and a grinding device. The first stirring tank is further in communication with a remote controller, where the remote controller is configured to send a first control command to the first stirring tank at a first time, and send a second control command to the first stirring tank at a second time, the first time being earlier than the second time.

### CROSS-REFERENCE TO RELATED APPLICATION

The present application is a continuation of International PCT Application Serial No. PCT/CN2024/102859, filed on Jul. 1, 2024, which claims priority to Chinese patent application No. 202311433807.X filed with China National Intellectual Property Administration on Nov. 1, 2023, and entitled “Stirring System for Lithium Iron Phosphate Slurry”. Both of the aforementioned applications are hereby incorporated by reference in their entireties.

### BACKGROUND

### Technical Field

The present application relates to, but is not limited to, a stirring system for lithium iron phosphate slurry.

### Description of Related Art

With the development of new energy technologies, the research on the production device of battery materials has also become a hot spot. A stirring system for lithium iron phosphate slurry is configured to mix a raw material of lithium iron phosphate and a solvent for dissolving in a stirring tank, and for further grinding to produce a slurry with small particle size and uniform particle size distribution. Based on this, how to improve the efficiency of the stirring system for lithium iron phosphate slurry is the key technical difficulty that is required to be overcome.

### SUMMARY

Some embodiments of the present application provide a stirring system for lithium iron phosphate slurry, which can improve the efficiency of the stirring system for lithium iron phosphate slurry and enhance the slurry performance.

The embodiments of the present application provide a stirring system for lithium iron phosphate slurry including: a first feeding mechanism, a second feeding mechanism, a first stirring tank, a homogenization pump, a first demagnetizing machine, a second stirring tank, a driving pump, a second demagnetizing machine, a heat exchanger and a grinding device;
a material outlet of the first feeding mechanism is connected to a first material inlet of the first stirring tank, a material outlet of the second feeding mechanism is connected to a second material inlet of the first stirring tank, a first material outlet of the first stirring tank is connected to a material inlet of the homogenization pump, a material outlet of the homogenization pump is connected to a material inlet of the first demagnetizing machine, and a material outlet of the first demagnetizing machine is connected to a third material inlet of the first stirring tank;
a second material outlet of the first stirring tank is connected to a first material inlet of the second stirring tank, a first material outlet of the second stirring tank is connected to a material inlet of the driving pump, a material outlet of the driving pump is connected to a material inlet of the second demagnetizing machine, a material outlet of the second demagnetizing machine is connected to a material inlet of the heat exchanger, and a material outlet of the heat exchanger is connected to a material inlet of the grinding device; and a material outlet of the grinding device is connected to a second material inlet of the second stirring tank;
the first stirring tank is further in communication with a remote controller, where the remote controller is configured to send a first control command to the first stirring tank at a first time, the first control command being configured to control a stirring speed of the first stirring tank to be greater than a preset speed threshold, and the remote controller is configured to send a second control command to the first stirring tank at a second time, the second control command being configured to control the stirring speed of the first stirring tank to be less than or equal to the preset speed threshold;
the grinding device includes a device body and a ceramic grinding assembly, the device body includes a grinding cylinder and a grinding shaft penetrating through the grinding cylinder, and the ceramic grinding assembly is provided within the grinding cylinder;
where, the ceramic grinding assembly includes a support unit, a connecting base, a first pressing base and a plurality of ceramic grinding members, the connecting base is provided to be opposite to the first pressing base along an axial direction of the support unit, the connecting base is constructed to be sleeved on the grinding shaft and to rotate synchronously with the grinding shaft; the support unit includes a plurality of support members, and the plurality of support members are disposed between the connecting base and the first pressing base and are configured to connect the connecting base and the first pressing base;
the plurality of ceramic grinding members are stacked on respective support members along the axial direction of the support member and are constructed to rotate synchronously with the connecting base when the connecting base rotates.

Further, the connecting base includes a first base body and a second base body,
the first base body includes a base-body and a fixing part, an end of the base-body away from the first pressing base has an assembly cavity, and the second base body is sleeved in the assembly cavity and is conically fitted with a cavity wall of the assembly cavity; the second base body is constructed to be sleeved on the grinding shaft to drive the first base body to rotate synchronously when the grinding shaft rotates;
the fixing part is disposed around a peripheral direction of the base-body and is connected to the base-body; the plurality of support members are evenly disposed on the fixing part and are fixedly connected to the fixing part.

Furthermore, the second base body is a conical sleeve, and an inner wall of an end of the base body away from the first pressing base has a ring-shaped protrusion, and an inner wall of the ring-shaped protrusion is enclosed to form the assembly cavity;
an inner wall of the assembly cavity is a conical surface compatible with a shape of a circumferential outer wall of the second base body;
in a direction from the connecting base to the first pressing base, a radial size of the conical sleeve gradually decreases.

Further, the circumferential outer wall of the second base body has at least two first half-holes, and the inner wall of the assembly cavity is provided with a second half-hole at a position corresponding to each first half-hole, and the second half-hole and the first half-hole are enclosed to form a connecting hole;
the connecting base further includes a fastener, and the fastener is threaded through the connecting hole;
the first half-hole is a threaded hole, a hole wall of the second half-hole has a smooth surface, and a height difference exists between the first half-hole and the second half-hole on a side facing the fastener;
the circumferential outer wall of the second base body has a third half-hole, a hole wall of the third half-hole has a smooth surface, and the inner wall of the assembly cavity is provided with a fourth half-hole at a position corresponding to the third half-hole; the fourth half-hole is a threaded hole, and the fourth half-hole and the third half-hole are enclosed to form a disassembly hole compatible with a structure of the fastener.

Further, the ceramic grinding member is provided with a through hole, and the support member is threaded through the through hole, and is elastically connected to a hole wall of the through hole.

Further, the first pressing base includes a first pressing base body and a first pressing unit, the first pressing unit includes a ring-shaped first pressing sheet, and the first pressing sheet is provided within the first pressing base body;
an end of each support member is threaded through the first pressing base body; the first pressing sheet has a first penetration hole with an adjustable hole size, and the end of the support member is threaded into the first penetration hole and detachably connected to the first pressing sheet;
a first pressing hole is further provided in a peripheral direction of the first pressing sheet, and the first pressing unit further includes a first pressing member, which is threaded into the first pressing hole to adjust a size of the first penetration hole during its screwing in the first pressing hole.

Further, the first pressing sheet includes a pressing body, a circumferential side wall of the pressing body is provided with a slot body at a position corresponding to each support member, and the first pressing sheet is provided with an elastic cantilever elastically connected to the pressing body in the slot body;
the pressing body and the elastic cantilever are each provided with an avoidance notch at a position corresponding to the same support member, and two avoidance notches are enclosed to form the first penetration hole;
the elastic cantilever is provided with a first hole part, and the slot body is provided with a second hole part at a position corresponding to the first pressing hole;
the first hole part and the second hole part form the first pressing hole together, and the first pressing member is successively threaded through the first hole part and the second hole part, so as to adjust a distance between the elastic cantilever and the slot body during its screwing.

Further, the ceramic grinding assembly further includes a second pressing base sleeved on each support member, the second pressing base being provided between the connecting base and the first pressing base, and configured to press on the connecting base and a part of the ceramic grinding member;
the second pressing base includes a second pressing base body, a second pressing unit and a pressing cover, the second pressing unit includes a ring-shaped second pressing sheet, one side of the second pressing sheet is provided in the second pressing base body; the pressing cover is configured to press onto the other side of the second pressing sheet and is constructed to be detachably connected with the grinding shaft;
each support member is threaded through the second pressing base body, and is detachably connected to the second pressing sheet;
the second pressing sheet is provided with a second penetration hole with an adjustable hole size, and the support member is threaded through the second penetration hole;
a second pressing hole is further provided in a peripheral direction of the second pressing sheet, and the second pressing unit further includes a second pressing member, which is threaded into the second pressing hole to regulate a size of the second penetration hole during its screwing in the second pressing hole.

Further, each of the plurality of ceramic grinding members stacked on respective support members includes a first grinding unit and a second grinding unit, the first grinding unit being disposed between the second pressing base and the connecting base, and the second grinding unit being disposed between the second pressing base and the first pressing base; a gap is provided between adjacent second grinding units for material circulation;
the ceramic grinding assembly further includes a limit sleeve, which is sleeved in a peripheral direction of the connecting base, and a limit notch is provided at a position corresponding to each support member in the peripheral direction of the limit sleeve;
the support member is threaded into the limit notch, and the first grinding unit is snapped in the limit notch;
the ceramic grinding assembly further includes a plurality of limit rods, each ceramic grinding member of the second grinding unit is provided with a limit hole, the limit rod is successively threaded through the limit hole of each ceramic grinding member, and is connected between the first pressing base and the second pressing base.

Further, the ceramic grinding member includes a first grinding member and a second grinding member, a hardness of the first grinding member is greater than a hardness of the second grinding member;
along the axial direction of the support member, the first grinding member and the second grinding member are alternately stacked on the same support member;
a grinding protrusion is provided in a periphery direction of the first grinding member, the grinding protrusion protruding from the exterior of the second grinding member; an elastic gasket is interposed between the first grinding member and the second grinding member.

In the stirring system for lithium iron phosphate slurry provided by the embodiments of the present application, the first feeding mechanism, the second feeding mechanism, the first stirring tank, the homogenization pump, and the first demagnetizing machine form a first dispersion system together; and the second stirring tank, the driving pump, the second demagnetizing machine, the heat exchanger and the grinding device form a second dispersion system together. The first stirring tank is further in communication with the remote controller, where the remote controller is configured to send the first control command to the first stirring tank at the first time, and send the second control command to the first stirring tank at the second time, where the first time is earlier than the second time. The first control command is configured to control a stirring speed of the first stirring tank to be greater than a preset speed threshold, and the second control command is configured to control the stirring speed of the first stirring tank to be less than or equal to the preset speed threshold. By this way, the first stirring tank can be controlled to agitate at a high speed at the first time for quickly integrating the lithium iron phosphate powder into the solvent, and to agitate at a low speed at the second time for preventing the material from settling, which improve the efficiency of the stirring system for lithium iron phosphate slurry and enhance the performance of the slurry. Based on this, by setting the ceramic grinding members in the ceramic grinding assembly, the hardness of the grinding members and the grinding performance of the ceramic grinding assembly can be improved to meet the hardness requirements for the grinding members in the stirring system of lithium iron phosphate slurry, so as to improve the particle size of the slurry output by the stirring system for lithium iron phosphate slurry.

### BRIEF DESCRIPTION OF THE DRAWINGS

In order to illustrate the technical solutions of embodiments of the present application or the prior art more clear, the accompanying drawings required in the descriptions of the embodiments or the prior art will be introduced simply hereinafter. Obviously, the accompanying drawings described hereinafter refer to some embodiments of the present application. For those skilled in the art, other accompanying drawings can be obtained based on these accompanying drawings without creative labor.

FIG. 1 is a structural schematic diagram of a stirring system for lithium iron phosphate slurry provided by some embodiments of the present application.

FIG. 2 is a structural schematic diagram of a grinding device provided by an embodiment of the present application.

FIG. 3 is a structural schematic diagram of a ceramic grinding assembly provided by an embodiment of the present application.

FIG. 4 is an exploded view of a ceramic grinding assembly provided by an embodiment of the present application.

FIG. 5 is a first cross-sectional view of FIG. 3 along an A-A direction.

FIG. 6 is a second cross-sectional view of FIG. 3 in the A-A direction.

FIG. 7 is a structural schematic diagram of a first pressing sheet provided by an embodiment of the present application.

FIG. 8 is a schematic diagram of an internal structure of the first pressing sheet in FIG. 7.

FIG. 9 is an assembly schematic diagram of a support member within the first pressing sheet according to an embodiment of the present application.

FIG. 10 is a structural schematic diagram of an anti-loose gasket in FIG. 9.

FIG. 11 is a schematic diagram of an internal structure of the ceramic grinding assembly provided by an embodiment of the present application.

FIG. 12 is a partial exploded view of a second pressing base provided by an embodiment of the present application.

FIG. 13 is a partial exploded view of the ceramic grinding assembly provided by an embodiment of the present application.

### REFERENCE SIGNS

100—Ceramic grinding assembly; 1—Support member; 2—Connecting base; 21—First base body; 211—Base body; 2111—Assembly cavity; 2112—Ring-shaped protrusion; 2113—Second half-hole; 2114—Fourth half-hole; 212—Fixing part; 2121—First mounting hole; 22—Second base body; 221—First half-hole; 222—Third half-hole; 223—Keyway; 224—Gap; 23—Fastener;
3—First pressing base; 31—First pressing base body; 311—Upper cover; 312—Lower cover; 32—First pressing sheet; 321—First penetration hole; 322—First pressing hole; 323—Disassembly groove; 324—Pressing body; 325—Elastic cantilever; 33—First pressing member; 34—Locking member; 35—Anti-loose gasket; 351—Bent part;
4—Ceramic grinding member; 41—First grinding member; 411—Grinding protrusion; 42—Second grinding member; 43—First grinding unit; 44—Second grinding unit; 5—Second pressing base; 51—Second pressing base body; 52—Second pressing sheet; 521—Second penetration hole; 522—Second pressing hole; 53—Pressing cover;
6—Limit sleeve; 7—Limit rod; 8—Turbine disk; 81—Arc-shaped protrusion; 82—Channel; 9—Sealing ring; 200—Grinding device; 210—Grinding shaft; 220—Grinding cylinder; 230—Separation device;
110—First stirring tank; 120—First demagnetizing machine; 130—Homogenization pump; 140—Second stirring tank; 150—Driving pump; 160—Second demagnetizing machine; 170—Heat exchanger; 180—Second feeding mechanism; 190—First feeding mechanism.

### DESCRIPTION OF THE EMBODIMENTS

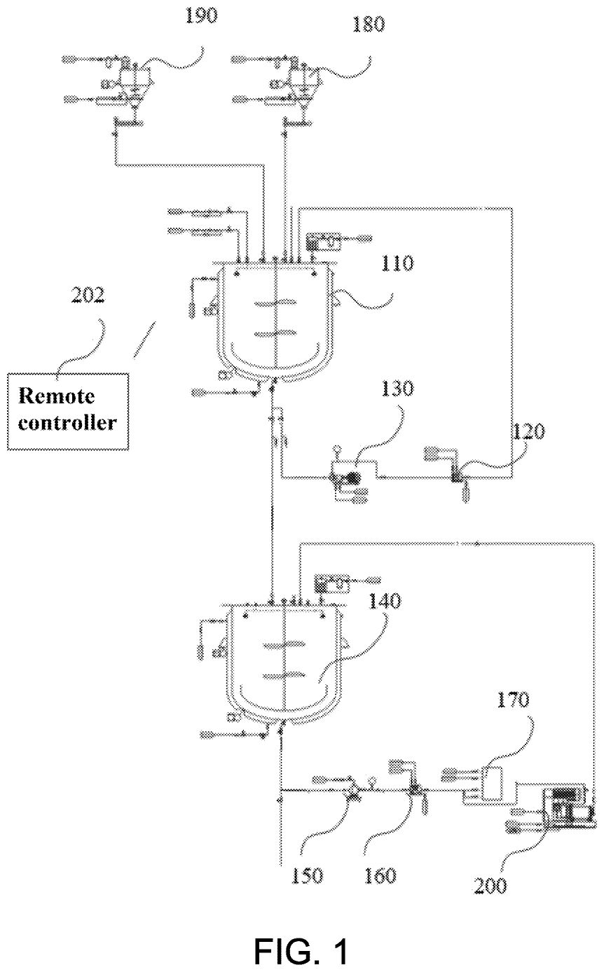

FIG. 1 shows a stirring system for lithium iron phosphate slurry provided by some embodiments of the present application. As shown in FIG. 1, the stirring system for lithium iron phosphate slurry includes a first feeding mechanism 190, a second feeding mechanism 180, a first stirring tank 110, a homogenization pump 130, a first demagnetizing machine 120, a second stirring tank 140, a driving pump 150, a second demagnetizing machine 160, a heat exchanger 170 and a grinding device 200.

A material outlet of the first feeding mechanism 190 is connected to a first material inlet of the first stirring tank 110, a material outlet of the second feeding mechanism 180 is connected to a second material inlet of the first stirring tank 110, a first material outlet of the first stirring tank 110 is connected to a material inlet of the homogenization pump 130, a material outlet of the homogenization pump 130 is connected to a material inlet of the first demagnetizing machine 120, and a material outlet of the first demagnetizing machine 120 is connected to a third material inlet of the first stirring tank 110.

A second material outlet of the first stirring tank 110 is connected to a first material inlet of the second stirring tank 140, a first material outlet of the second stirring tank 140 is connected to a material inlet of the driving pump 150, a material outlet of the driving pump 150 is connected to a material inlet of the second demagnetizing machine 160, a material outlet of the second demagnetizing machine 160 is connected to a material inlet of the heat exchanger 170, a material outlet of the heat exchanger 170 is connected to a material inlet of the grinding device 200, and a material outlet of the grinding device 200 is connected to a second material inlet of the second stirring tank 140.

The first feeding mechanism 190 and the second feeding mechanism 180 are configured to introduce lithium iron phosphate powder into the first stirring tank 110 and to inject a solvent into the first stirring tank 110 through pipes. The first stirring tank 110 is configured to mix the lithium iron phosphate powder with the solvent, and the mixed slurry goes through the homogenization pump 130 for fracturing and then goes through the first demagnetizing machine 120 for demagnetizing treatment and then returns to the first stirring tank 110. After repeating for preset number of times, the slurry is cut by the homogenization pump 130 to form a slurry with a smaller particle size so as to improve the dispersion of the lithium iron phosphate powder in the solvent and the uniformity of the slurry.

Then, the slurry in the first stirring tank 110 enters into the second stirring tank 140; and after the material outlet of the second stirring tank 140 is opened, the slurry is sucked from the second stirring tank 140 by the driving pump 150, and then goes through the second demagnetizing machine 160 and the heat exchanger 170 and enters into the grinding device 200. The slurry is ground by the grinding device 200 and returns to the second stirring tank 140. This process is repeated, such that the slurry is ground by the grinding device 200 to form a slurry with a smaller particle size, further improving the dispersion of the lithium iron phosphate powder in the solvent and the uniformity of the slurry.

The stirring system for lithium iron phosphate slurry further includes a remote controller 202. The first stirring tank 110 is further in communication with the remote controller 202, the remote controller 202 is configured to send a first control command to the first stirring tank 110 at a first time, and the first control command is configured to control a stirring speed of the first stirring tank 110 to be greater than a preset speed threshold. The remote controller 202 is configured to send a second control command to the first stirring tank 110 at a second time, the second control command is configured to control a stirring speed of the first stirring tank 110 to be less than or equal to the preset speed threshold, and the first time is earlier than the second time. Thus, the first stirring tank 110 can be controlled to agitate at a high speed at the first time for quickly blending the lithium iron phosphate powder (hereinafter referred to as “the powder”) into the solvent, and to agitate at a low speed at the second time for preventing the material (hereinafter referred to as “the powder”) from settling, which improves the efficiency of the stirring system for lithium iron phosphate slurry and enhances the performance of the slurry.

In some embodiments, the first stirring tank 110 has a high-speed dispersion disk in the center of its stirring shaft, which has a speed up to 1400 rpm/min and is used for preliminary dispersion and dissolution between the powder and the solvent. After the dispersion is completed, a low-speed stirring (a speed being greater than 0 and less than or equal to 89 rpm/min) can be performed. The stirring method combining spiral stirring, frame stirring, double-layer folding propeller and anchor stirring in the existing technologies is adopted to increase axial flow and longitudinal flow. This mainly aims to fully make the material flow during circulation, prevent the material from settling. The anchor stirring at a lowest point can prevent the deposition of the material at a low liquid level. A baffle is added on an inner wall of the liquid tank, which can increase the turbulence intensity of the material, so that the material can be stirred more evenly. The structure of the first stirring tank 110 can refer to the structure of the stirring tank in the existing technologies, which is not described in detail here.

Each grinding device has a plurality of grinding members for grinding the material, and the hardness of the grinding members significantly influences the grinding effect on the material. Generally speaking, when the particle size of the material and other grinding conditions such as the speed of the grinding device remain constant, the harder the grinding members, the better the grinding effect on the material. In order to meet the higher requirements for the fineness of the ground slurry, higher requirements are put forward for the hardness of grinding member.

The grinding members in the existing grinding devices are mainly plastic products prepared from high-molecular materials, such that the hardness of the grinding members is unable to meet the grinding requirements for the grinding device in the stirring system for lithium iron phosphate slurry, which will affect the particle size of the slurry output by the stirring system for lithium iron phosphate slurry.

In view of the above, the embodiments of the present application provide a grinding device 200, and the grinding device includes a ceramic grinding assembly. Since ceramics have higher hardness than the plastic products prepared from high-molecular-materials, by providing the plurality of ceramic grinding members in the ceramic grinding assembly, the hardness of the grinding members and the grinding performance of the ceramic grinding assembly can be improved to meet the hardness requirements for the grinding members in the stirring system of lithium iron phosphate slurry, so as to improve the particle size of the slurry output by the stirring system for lithium iron phosphate slurry.

Hereinafter, the structure of the grinding device and the ceramic grinding assembly of the present application will be further illustrated in combination with the accompanying drawings and the embodiments.

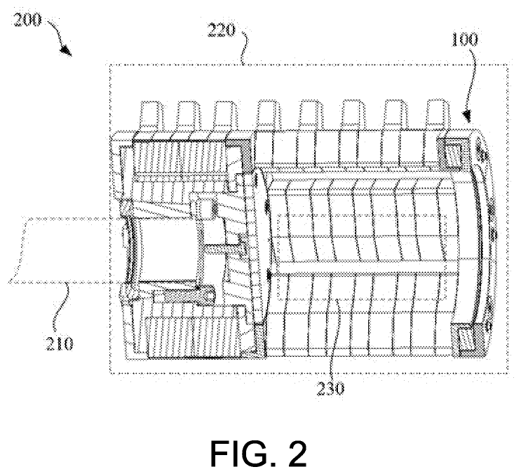

Referring to FIG. 2, the grinding device 200 includes a device body and a ceramic grinding assembly 100. The device body includes a grinding cylinder 220 and a grinding shaft 210 extending through the grinding cylinder 220, and the ceramic grinding assembly 100 is provided within the grinding cylinder 220 and connected to the grinding shaft 210, so as to rotate under the drive of the grinding shaft 210 for grinding the material between the grinding cylinder 220 and the ceramic grinding assembly 100. A grinding chamber of the grinding device 200 can be formed between the grinding cylinder 220 and the ceramic grinding assembly 100. The grinding cylinder 220 is provided with a material inlet (not shown), through which the slurry can enter into the grinding chamber, so as to grind the material in the slurry by the ceramic grinding assembly 100.

The device body may include a grinding motor, the grinding motor having a grinding shaft 210, so that when the grinding motor is started, it can drive the grinding shaft 210 to rotate and drive the ceramic grinding assembly 100 to rotate synchronously for grinding the material in the grinding chamber. After the material is ground, it can enter into the ceramic grinding assembly 100, so that the grinding medium wrapped by the slurry is separated by a separation device 230 assembled in the ceramic grinding assembly 100 to obtain the desired slurry.

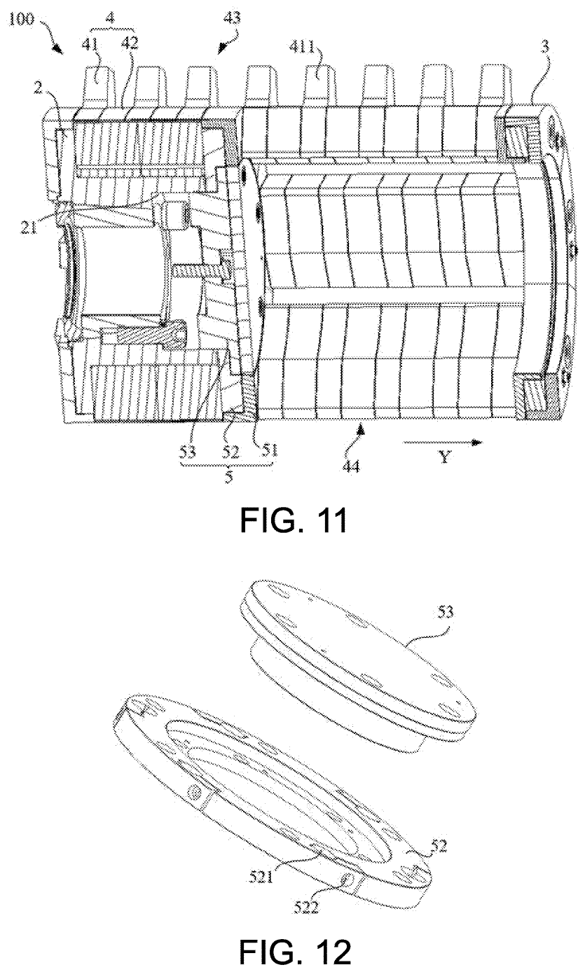

The device body may further include the separation device 230, which may include, but is not limited to, a centrifugal separation device or a spiral separation device. Referring to FIG. 2 in combination with FIG. 11, at least partial structure of the separation device 230 can be provided within the ceramic grinding assembly 100, and between a first pressing base 3 and a second pressing base 5 of the ceramic grinding assembly 100, such that when the separation device 230 rotates, the slurry can be separated from the grinding medium to obtain the desired slurry.

The structure of the first pressing base 3 and second pressing base 5, and their positions within the ceramic grinding assembly 100 will be further illustrated hereinafter in combination with the specific accompanying drawings.

It should be noted that the device body can be understood as the structure of the grinding device 200 except the ceramic grinding assembly 100. Besides the separation device 230, the device body may further include the grinding motor, etc. The grinding motor can be connected to the separation device 230 to drive the separation device 230 to rotate so as to separate the material from the grinding medium.

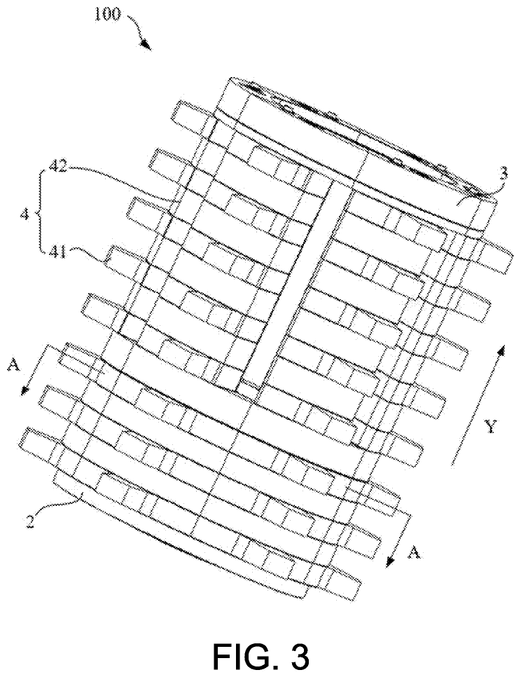

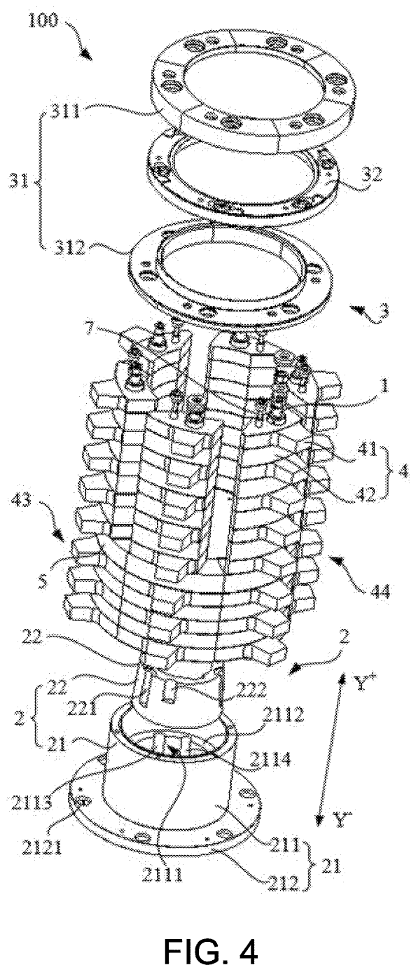

Referring to FIG. 3 and FIG. 4, the ceramic grinding assembly 100 includes a support unit, a connecting base 2, a first pressing base 3, and a plurality of ceramic grinding members 4. The connecting base 2 is disposed oppositely to the first pressing base 3 along an axial direction of the support unit. That is, the connecting base 2 and the first pressing base 3 are disposed face-to-face along the axial direction of the support unit, so as to facilitate the arrangement of the support unit. The axial direction of the support unit can refer to the Y direction in FIG. 3 and FIG. 4.

Referring to FIG. 4 and FIG. 2, the connecting base 2 is constructed to be sleeved on the grinding shaft 210 and to rotate synchronously with the grinding shaft 210. It should be noted that synchronous rotation can be understood as rotating in the same direction at the same time. By the connecting base 2 being sleeved on the grinding shaft 210, the connecting base 2 is assembled on the grinding shaft 210, while the connecting base 2 can also rotate simultaneously with the grinding shaft 210 towards the same direction when the grinding shaft 210 rotates.

Referring to FIG. 4, the support unit includes a plurality of support members 1, the plurality of support members 1 are provided between the connecting base 2 and the first pressing base 3 and is configured to connect the connecting base 2 and the first pressing base 3, so as to fix the support member 1 between the connecting base 2 and the first pressing base 3. The support member 1 can be a supporting rod, and an end surface of the supporting rod upwardly along its shaft can have a circular shape or other shapes. The number of the support member 1 can be four, five, six, eight, etc. FIG. 4 shows six support members 1, which will not tend to limit the structure of the ceramic grinding assembly 100. In the present application, the structure and the quantity of the support member 1 are not further limited.

A plurality of ceramic grinding members 4 are stacked and provided on respective support members 1 along an axial direction of the support members 1. The plurality of ceramic grinding members 4 are constructed to rotate synchronously with the connecting base 2 when the connecting base 2 rotates, so that the plurality of ceramic grinding members 4 rotate under the drive of the connecting base 2 and the support members 1, for grinding the material during the rotation of the ceramic grinding members 4, to achieve the grinding function of the ceramic grinding assembly 100.

In addition, since the ceramic grinding member 4 has a higher hardness than the grinding members in the existing grinding devices, it can not only meet the hardness requirements of the grinding device 200 for the ceramic grinding member 4, but also enable the ceramic grinding assembly 100 to achieve a good grinding effect on the material.

Since ceramics are generally brittle and cannot be directly connected to the grinding shaft 210 by interference-fit, the present application is provided with the connecting base 2 and the plurality of support members 1, so that the ceramic grinding members 4 can be assembled to the grinding shaft 210 through the support members 1 and the connecting base 2, avoiding a direct interference-fit connection between the ceramic grinding members 4 and the grinding shaft 210. In addition, when the grinding shaft 210 rotates, the power from the grinding shaft 210 is first indirectly transmitted to the plurality of support members 1 through the connecting base 2, and then the torque generated by the grinding shaft 210 is transmitted to the ceramic grinding members 4 through the plurality of support members 1, so as to achieve the synchronous rotation of the ceramic grinding members 4, achieving the grinding function of the ceramic grinding assembly 100.

Referring to FIG. 4, in some embodiments, the connecting base 2 can include a first base body 21 and a second base body 22, and ends of the plurality of support members 1 are fixed circumferentially on the first base body 21, so that the support members 1 are assembled on the connecting base 2. The second base body 22 is nested inside the first base body 21 and is constructed to be sleeved on the grinding shaft 210.

Referring to FIG. 4, the first base body 21 includes a base body 211 and a fixing part 212, and the base body 211 is provided with an assembly cavity 2111 at one end away from the first pressing base 3. The second base body 22 is provided within the assembly cavity 2111 and is conically fitted with a cavity wall of the assembly cavity 2111. The second base body 22 is constructed to be sleeved on the grinding shaft 210 such that it drives the first base body 21 to rotate synchronously with the grinding shaft 210 when the grinding shaft 210 rotates, allowing the first base body 21 to be assembled on the grinding shaft 210 via the second base body 22, and enabling the support members 1 to be connected to the grinding shaft 210. At the same time, the first base body 21 can also drive the plurality of ceramic grinding members 4 on the support members 1 to rotate synchronously via the support members 1 when the grinding shaft 210 rotates.

By the configuration of the second base body 22 being conically fitted with the cavity wall of the assembly cavity 2111, it achieves that the second base body 22 is provided within the first base body 21 and achieves the transmission between the second base body 22 and the first base body 21. Meanwhile, compared with a non-conical fit between the second base body 22 and the cavity wall of the assembly cavity 2111, it is convenient for disassembling the first base body 21.

The fixing part 212 is disposed around the base body 211 and is connected to the base body 211. The plurality of support members 1 are distributed evenly on the fixing part 212 and fixedly connected to the fixing part 212, so as to achieve the connection between each support member 1 and the first base body 21; and the position of each support member 1 is fixed relative to the first base body 21, so that the support member 1 can rotate synchronously with the first base body 21 when the first base body 21 rotates, and can transmit the torque generated by the grinding shaft 210 to the ceramic grinding member 4, so as to drive the ceramic grinding member 4 to rotate.

The fixing part 212 can be connected to the base body in an integrated manner, or, the fixing part 212 can also be connected to the base body 211 in a non-integrated manner such as snap-fit, fastener and the like. In the present application, the connection manner between the fixing part 212 and the base body 211 is not further limited.

It should be noted that the fixing part 212 is provided with a first mounting hole 2121 at a position corresponding to each support member 1, so that an end of each support member 1 can be inserted into the corresponding first mounting hole 2121 and form an interference fit with the fixing part 212. Thus, it can achieve a fixed connection of the support member 1 on the fixing part 212, so that the position of each support member 1 is stationary relative to the first base body 21. Alternatively, each support member 1 can also be connected to the fixing part 21 by welding or other means, and its position is stationary relative to the first base body 21. In the present application, the manner of connection between the support member 1 and the fixing part 212 is not further limited.

Referring to FIG. 4, the second base body 22 can be a conical sleeve, and an inner wall of the end of the base body 211 away from a first pressing base 3 has a ring-shaped protrusion 2112, and an inner wall of the ring-shaped protuberance 2112 is enclosed to form the assembly cavity 2111. An inner wall of the assembly cavity 2111 is a conical surface compatible with the shape of a circumferential outer wall of the second base body 22. The circumferential outer wall of the second base body 22 can be understood as an outer wall of the side of the second base body 22 facing the inner wall of the assembly cavity 2111 in a circumferential direction of the second base body 22. The conical surface of the assembly cavity 2111 being compatible with the shape of the circumferential outer wall of the second base body 22 can be understood that the conical surface of the assembly cavity 2111 and the circumferential outer wall of the second base body 22 have same or similar shape, so that when the second base body 22 is provided within the assembly cavity 2111, it can form a good fit with the cavity wall of the assembly cavity 2111 while achieving a conical fit between the second base body 22 and the cavity wall of the assembly cavity 2111.

In addition, since the ring-shaped protrusion 2112 is disposed on the inner wall of the end of the base body 211 away from the first pressing base 3, it can achieve the conical fit between the second base body 22 and the cavity wall of the assembly cavity 2111, and at the same time, it can reserve a certain disassembly space at the end of the base body 211 facing the first pressing base 3, which is convenient for disassembling the first base body 21.

Referring to FIG. 4, in some embodiments, along a direction from the connecting base 2 to the first pressing base 3, a radial size of the conical sleeve gradually decreases. The direction from the connecting base 2 to the first pressing base 3 can refer to the Y+direction in FIG. 4. The radial size of the conical sleeve may include an inner diameter and an outer diameter of the cone sleeve. By defining the radial size of the conical sleeve, it can make the radial size of the end of the second base body 22 facing the connecting base 2 to be larger than the radial size of the end of the second base body 22 facing the first pressing base 3, so that the first base body 21 is sleeved on the second base body 22 along the Y+direction, or the first base body 21 is separated from the second base body 22 along the Y-direction and disassembled from the second base body 22.

An included angle formed by two outermost edges of the second base body 22 along its two axial sides can be 6 degrees to 10 degrees. For example, the included angle can be 6 degrees, 7 degrees, 8 degrees, 9 degrees, or 10 degrees, etc. In the present application, the angle of the second base body 22 at this included angle is not further limited.

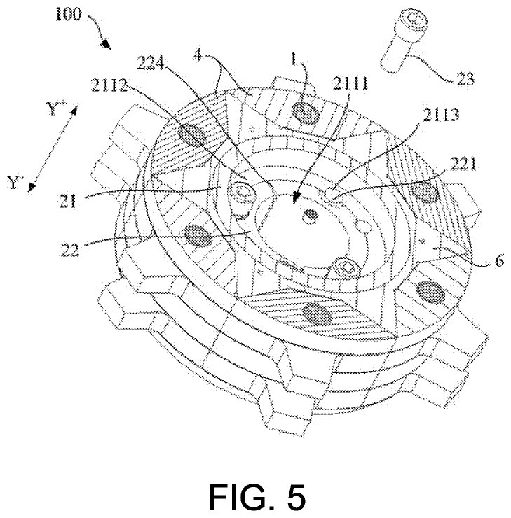

Referring to FIG. 4 and FIG. 5, the circumferential outer wall of the second base body 22 is provided with at least two first half-holes 221. The inner wall of the assembly cavity 2111 is provided with second half-holes 2113 at the position corresponding to each first half-hole 221, and the second half-hole 2113 and the first half-hole 221 are enclosed to form a connecting hole. The connection base 2 further includes a fastener 23, which is threaded through the connecting hole to achieve the connection between the first base body 21 and the second base body 22.

The first half-holes 221 can be two, three or four in number, etc. The number of the first half-holes 221 is not further limited in the present application. At least two first-half holes 221 can be evenly distributed on the circumferential outer wall of the second base body 22 to enhance the stability of the connection between the first base body 21 and the second base body 22.

In some embodiments, the first half-hole 221 can be a threaded hole, and a hole wall of the second half-hole 2113 is a smooth surface. A height difference exists between the first half-hole 221 and the second half-hole 2113 on a side facing the fastener 23, so that the fastener 23 can be threaded through the connecting hole and can press against the first base body 21 during its screwing in the first half-hole 221. This enables the first base body 21 to move along the Y+direction relative to the second base body 22, thus forming a conical fit with the second base body 22.

Referring to FIG. 5, in order to achieve that the fastener 23 presses against the first base body 21, an end of the second base body 22 facing the fastener 23 is further provided with an avoidance groove (not shown), and the avoidance groove is provided on a peripheral side of the first half-hole 221 and is communicated with the first half-hole 221, so that a side of the first half-hole 221 facing the fastener 23 is lower than a side of the second half-hole 2113 facing the fastener 23. This enables the fastener 23 to firstly press against the first base body 21, to make the first base body move along the Y-direction relative to the second base body 22 during its screwing in the first half-hole 221.

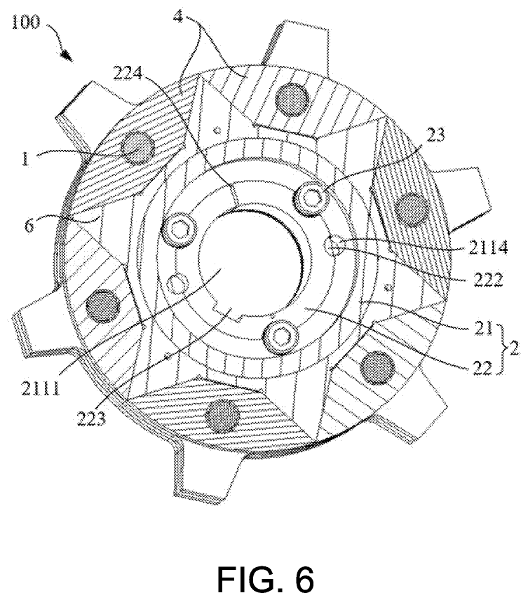

The assembling effect of the fastener 23 in the connecting hole can refer to FIG. 6. After the first base body 21 and the second base body 22 are connected, the fastener 23 can be provided within the disassembly space.

It should be noted that in some other embodiments, the first half-hole 221 and the second half-hole 2113 may further be half-threaded holes which are connected with each other. The structure of the first half-hole 221 and the second half-hole 2113 will not be further limited in the present application.

Referring to FIG. 6, in order to facilitate the disassembly of the first base body 21, the circumferential outer wall of the second base body 22 is provided with a third half-hole 222, and a hole wall of the third half-hole 222 is a smooth surface. The inner wall of the assembly cavity 2111 is provided with a fourth half-hole 2114 at the position corresponding to the third half-hole 222. The fourth half-hole 2114 is a threaded hole. The fourth half-hole 2114 and the third half-hole 222 are enclosed to form a disassembly hole compatible with the structure of the fastener 23, so that the fastener 23 can be assembled in the disassembly hole after the fastener 23 is unscrewed from the connecting hole, achieving the disassembly of the first base body 21 from the second base body 22.

Referring to FIG. 6, in some embodiments, a length of the third half-hole 222 can be shorter than a length of the fourth half-hole 2114, such that when the first base body 21 is conically fitted with the second base body 22, a hole bottom of the third half-hole 222 is higher than a hole bottom of the fourth half-hole 2114. In this way, when the fastener 23 is threaded through the disassembly hole and during its screwing, it can firstly abut against the hole bottom of the third half-hole 222. Through continued screwing in the disassembly hole, the first base body 21 can smoothly move relative to the second base body 22 along the Y-direction (not shown, see FIG. 4 or FIG. 5) and is detached from the second base body 22, ultimately achieving the disassembly of the first base body 21 from the second base body 22.

The number of third half-hole 222 can be one, two, etc. The number of the third half-hole 222 will not be further limited in the present application. When the number of the third half-hole 222 is greater than or equal to two, each of the third half-holes 222 can be evenly distributed on the circumferential outer wall of the second base body 22 to enhance the stability of the second base body 22 under stress during disassembly of the first base body 21. The third half-hole 222 and the first half-hole 221 can be disposed at intervals around the periphery direction of the second base body 22.

In other embodiments, the third half-hole 222 and the fourth half-hole 2114 may also be half-threaded holes which are connected with each other. In the present application, the structure of the third half-hole 222 and the fourth half-hole 2114 will not be further limited.

Referring to FIG. 6, a circumferential inner wall of the second base body 22 is provided with a keyway 223, and the second base body 22 is provided with a long slit 224, a length direction of which is parallel to an axial direction of the second base body 22, so that the second base body 22 is sleeved on the grinding shaft 210. After the second base body 22 is key-connected with the grinding shaft 210 through the keyway 223, it is convenient to achieve the interference fit between the second base body 22 and the grinding shaft 210 due to the existence of the slit 224. The axial direction of the second base body 22 can refer to the Y direction in FIG. 1.

If the first base body 21 and the second base body 22 can be made of the same metal material, then the contact surfaces of the first base body 21 and the second base body 22 may be adhered to each other under the action of molecular motions, which is not convenient for the disassembly of the first base body 21.

Based on this, in the present application, the first base body 21 and the second base body 22 are made of different metal materials, so as to avoid that the contact surfaces of the first base body 21 and the second base body 22 are adhered to each other when the first base body 21 and the second base body 22 are made of same material and form a conical fit, which is beneficial for the disassembly of the first base body 21. For example, the first base body 21 can be made of alloy steel such as martensitic stainless steel or other metal materials, and the second base body 22 can be made of gray cast iron or other metal materials. The material of the first base body 21 and the second base body 22 is not further limited in the present application.

It should be noted that in other embodiments, the connecting base 2 may merely include the first base body 21, and the first base body 21 may sleeved on the grinding shaft 210, so as to achieve the assembling of the connecting base 2 on the grinding shaft 210 while still enabling the power of the grinding shaft 210 to indirectly transmit to the support member 1.

Referring to FIG. 6, the ceramic grinding member 4 has a through hole (not shown), and the support member 1 is threaded through the through hole and is elastically connected with an inner wall of the through hole, so that the support member 1 is threaded through the ceramic grinding member 4. It can achieve the interference fit of the ceramic grinding member 4 on the support member 1, and at the same time, it can prevent the support member 1 from directly contacting and pressing the ceramic grinding member 4, so as to ensure the structural integrity of the ceramic grinding member 4.

Specifically, a circumferential outer wall of the ceramic grinding member 4 may be wrapped with an elastic sleeve (not shown), so that the support member 1 is threaded through the through hole, and the support member 1 can be elastically connected to the hole wall of the through hole through the elastic sleeve. The elastic sleeve can be made of a high-molecular material with elasticity. Herein, the high-molecular material for preparing the elastic sleeve can include, but is not limited to, polytetrafluoroethylene or other high-molecular materials with elasticity.

Referring to FIG. 4, the first pressing base 3 includes a first pressing base body 31 and a first pressing unit. The first pressing unit includes a ring-shaped first pressing sheet 32, and the first pressing sheet 32 is provided within the first pressing base body 31, so as to achieve the assembling of the first pressing sheet 32 within the first pressing base body 31. The end of each support member 1 is threaded through the first pressing base body 31 and detachably connected to the first pressing sheet 32, so as to fix each support member 1 in the first pressing base body 31.

It should be noted that, by providing the first pressing base 3, the plurality of ceramic grinding members 4 on each support member 1 can be fixed to prevent the plurality of ceramic grinding members 4 from moving along the axial direction of the support member 1. In applications, when the length of the support member 1 and the number of the ceramic grinding members 4 connected with support member 1 are constant, the distance between the first pressing base 3 and the connecting base 2 can be adjusted to avoid too large pressure borne by each ceramic grinding member 4.

Referring to FIG. 4, the first pressing base body 31 includes an upper cover 311 and a lower cover 312, and the upper cover 311 and the lower cover 312 are disposed oppositely along the axial direction of the support member 1 and enclosed to form the first pressing base body 31 having an internal cavity. Each of the upper cover 311 and the lower cover 312 is provided with a through hole at the position corresponding to each support member 1, so that the support member 1 can be threaded through the through holes of the upper cover 311 and the lower cover 312 and detachably connected with the upper cover 311 through a fastener (not shown).

The first pressing sheet 32 is accommodated within the cavity of the first pressing base body 31. In some embodiments, the first pressing base 3 may further include a gasket (not shown) and a washer (not shown), and gaskets may be further disposed between the first pressing sheet 32 and the lower cover 312 and between the first pressing sheet 32 and the upper cover 311, and the washer may be further disposed around the periphery of the first pressing sheet 32, so that the arrangement of the gasket and the washer can avoid that the first pressing sheet 32 contacts directly with the upper cover 311 and the lower cover 312.

It should be noted that all of the upper cover 311, the lower cover 312, and the first pressing sheet 32 can be made of metal materials. In order to avoid that the lower cover 312 directly contacts with the ceramic grinding member 4 on each support member 1, an elastic gasket is further provided between each ceramic grinding member 4 and the lower cover 312 to prevent each ceramic grinding member 4 from bearing excessive pressure when being pressed by the first pressing base 31.

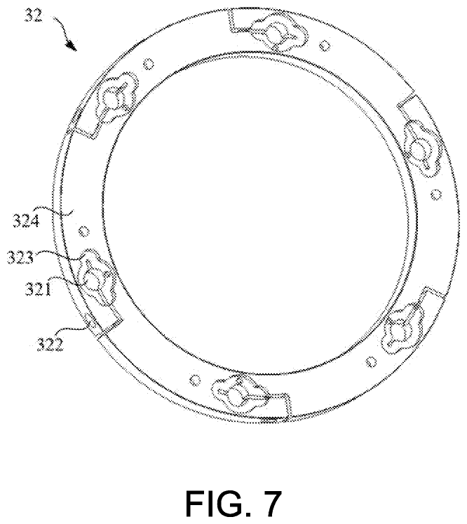

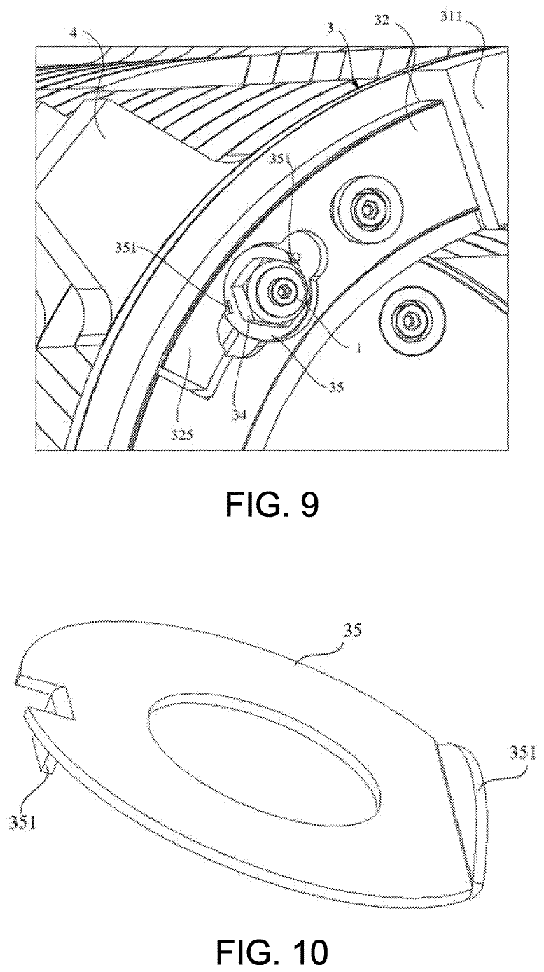

Referring to FIG. 7 and FIG. 9, the first pressing sheet 32 has a first penetration hole 321 with an adjustable hole size, and the end of the support member 1 is threaded through the first penetration hole 321 and is detachably connected to the first pressing sheet 32.

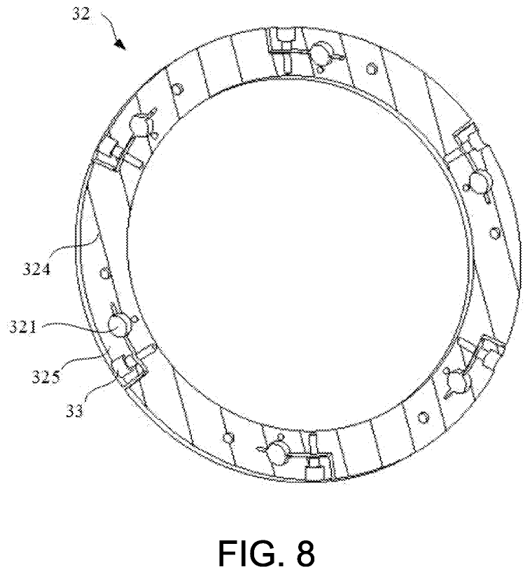

Referring to FIG. 7 and FIG. 8, a peripheral direction of the first pressing sheet 32 is further provided with a first pressing hole 322, and the first pressing unit further includes a first pressing member 33, which is threaded through the first pressing hole 322 to adjust the size of the first penetration hole 321 during its screwing in the first pressing hole 322.

Referring to FIG. 4, FIG. 7, FIG. 8 and FIG. 9, in this way, when the end of the support member 1 passes through the through hole of the lower cover 312 and is threaded through the first penetration hole 321, during the process where the first pressing member 33 is continuously screwed in the first pressing hole 322 towards a side where the first penetration hole 321 is located, it can press the part of the first pressing sheet 32 having the first pressing hole 322 to reduce the size of the first penetration hole 321, so as to enable the support member 1 to contact with the hole wall of the first penetration hole 321, and to form a tight fit (e.g. interference fit) with the first pressing sheet 32 in the first penetration hole 321, so that the first pressing sheet 32 can rotate synchronously with the support member 1.

Similarly, during the process where the first pressing member 33 is continuously screwed in the first pressing hole 322 towards the side away from the first penetration hole 321, the pressure applied to the first pressing sheet 32 can be released, so as to enlarge the size of the first penetration hole 321, which is convenient for achieving the disassembly of the support member 1.

Referring to FIG. 7 and FIG. 9, in some embodiments, in order to facilitate the disassembly of the support member 1, the first pressing sheet 32 is further provided with a detachment groove 323 in the periphery of the first penetration hole 321, and the detachment groove 323 is communicated with the first penetration hole 321, allowing the staff to place his fingers in the detachment groove 323 when disassembling the support member 1, which is conductive for the disassembly of the support member 1.

Referring to FIG. 8 and FIG. 9, the first pressing sheet 32 includes a pressing body 324, and a circumferential side wall of the pressing body 324 has a slot body (not shown) at the position corresponding to each support member 1. The first pressing sheet 32 is provided with an elastic cantilever 325 elastically connected with the pressing body 324 in the slot body. The pressing body 324 and the elastic cantilever 325 are both provided with an avoidance notch (not marked) at the position corresponding to the same support member 1, and two avoidance notches are enclosed to form the first penetration hole 321, so that when the elastic cantilever 325 displaces relative to the pressing body 324 under pressure, the size of the first penetration hole 321 can be adjusted.

Referring to FIG. 7 and FIG. 8, the elastic cantilever 325 is provided with a first hole part (not shown), and the slot body is provided with a second hole part (not shown) at the position corresponding to the first pressing hole 322. The first hole part and the second hole part form the first pressing hole 322. The first pressing member 33 is successively threaded through the first hole part and the second hole part, so as to adjust the distance between the elastic cantilever 325 and the slot body during screwing, so that the elastic cantilever 325 displaces relative to the pressing body 324 under the action of the pressure of the first pressing member 33, achieving the purpose of adjusting the size of the first penetration hole 321.

Where, at least one of the first hole part and second hole part can be a threaded hole, which is convenient for screwing of the first pressing member 33. Specifically, during the process where the first pressing member 33 is continuously screwed towards the second hole part within the first hole part, it can press the elastic cantilever 325 and make the elastic cantilever 325 move towards the side of the slot body provided with the second hole part, so as to reduce the size of the first penetration hole 321. Similarly, during the process where the first pressing part 33 is continuously screwed in the first hole part towards the side away from the second hole part, the pressure applied to the elastic cantilever 325 can be released, which makes the elastic cantilever 325 move away from the side of the slot body provided with the second hole part, so as to increase the size of the first penetration hole 321.

It should be noted that the elastic cantilever 325 is integrated with a first side slot wall of the slot body, and an end of the elastic cantilever 325 extends along a peripheral direction of the pressing body 324 towards a second side slot wall of the slot body, with gaps formed between the end of the elastic cantilever 325 and the second side slot wall, as well as between the end of the elastic cantilever 325 and a slot bottom of the slot body. The second hole part is located on the slot bottom of the slot body. This causes the elastic cantilever 325 to be displaced relative to the pressing body 324 under the action of pressure, thereby regulating the size of the first penetration hole 321.

Referring to FIG. 7 and FIG. 9, in some embodiments, when the end of the support member 1 is threaded into the first penetration hole 321, it can be threadably connected to a locking fastener 34 such as a nut to achieve a detachable connection between the support member 1 and the first pressing sheet 32.

Referring to FIG. 9, in some embodiments, in order to prevent the locking fastener 34 from loosening during the rotation of the support member 1, the first pressing base body 31 is further provided with an anti-loose gasket 35 inside at a position corresponding to each support member 1. The anti-loose gasket 35 may be sleeved on the end of the support member 1 and located between the upper cover 311 and the first pressing sheet 32, so that during the rotation of the support member 1, the rotation of the locking fastener 34 relative to the support member 1 is limited by the anti-loose gasket 35, thus ensuring a stable connection between the locking fastener 34 and the support member 1.

Referring to FIG. 10, two bent parts 351 bent towards different directions are provided in a peripheral direction of the anti-loose gasket 35. When the anti-loose gasket 35 is sleeved on the end of the support member 1, the two bent parts 351 can be provided on different sides of the locking fastener 34, so as to block the locking fastener 34 from rotating relative to the support member 1, achieving the anti-loosening effect.

It should be noted that in some embodiments, there may also be one or more bent parts 351. Or, the anti-loose gasket 35 may also have other structures. The structure of the anti-loose gasket 35 is not further limited in the present application.

Referring to FIG. 11, in some embodiments, the ceramic grinding assembly 100 may further include a second pressing base 5 that is sleeved on each support member 1, where the second pressing base 5 is provided between the connecting base 2 and the first pressing base 3 and press against the connecting base 2 and a portion of the ceramic grinding member 4, which not only prevents the connecting base 2 or a portion of the ceramic grinding member 4 from moving along the Y direction, while also blocking the end of the connecting base 2 facing the first pressing base 3.

Referring to FIG. 2 and FIG. 11, partial structure of the second pressing base 5 is constructed to be detachably connected to the grinding shaft 210, so that the second pressing base 5 can be connected to the grinding shaft 210 while being able to press against the connecting base 2.

Referring to FIG. 11, the second pressing base 5 can include a second pressing base body 51, a second pressing unit (not shown) and a pressing cover 53, the second bonding unit includes a ring-shaped second pressing sheet 52, and a side of the second pressing sheet 52 is located within the second pressing base body 51.

Referring to FIG. 11 and FIG. 12, the pressing cover 53 presses on the other side of the second pressing sheet 52 and is constructed to be detachably connected to the grinding shaft 210, so that the pressing cover 53 can press on the first base body 21 after being connected to the grinding shaft 210 and block the end of the first base body 21 facing the first pressing base 3. Where, the pressing cover 53 can be connected to the grinding shaft 210 by bolts or screws or other fasteners, so as to facilitate the disassembly of the second pressing base 5 and the connecting base 2.

Referring to FIG. 11, each support member 1 (not shown) is threaded into the second pressing base body 51 and detachably connected to the second pressing sheet 52, so as to achieve that each support member 1 is fixed within the second pressing base body 51.

The structure of the second pressing base 5 is the same as the structure of the upper cover 311, which is not described repeatedly herein.

Referring to FIG. 12, the second pressing sheet 52 is provided with a second penetration hole 521 with an adjustable hole size, and the support member 1 is threaded through the second penetration hole 521. A second pressing hole 522 is also disposed at a peripheral direction of the second pressing sheet 52. The second pressing unit further includes a second pressing member (not shown) which is inserted into the second pressing hole 522, to regulate the size of the second penetration hole 521 during its screwing in the second pressing hole 522. This enables the support member 1 to form a tight fit with the second pressing sheet 52 in the second penetration hole 521, or facilitates the disassembly of the support member 1 from the second pressing base 5.

It should be noted that the formation of the second penetration hole 521 and the second pressing hole 522 in the second pressing sheet 52, and the regulation principle of the size of the second penetration hole 521 by the second pressing member can refer to the relevant description regarding the first pressing base 3 as above, which will not be repeated herein.

Referring to FIG. 11, each of the plurality of ceramic grinding members 4 stacked on each support member 1 includes a first grinding unit 43 and a second grinding unit 44, the first grinding unit 43 is provided between the second pressing base 5 and the connecting base 2, and the second grinding unit 44 is provided between the second pressing base 5 and the first pressing base 3. There is a gap between adjacent second grinding units 44 for the material circulation, so that during the rotation of the ceramic grinding members 4 for grinding the material, the ground material can enter into the interior of the ceramic grinding assembly 100 through the gap between the adjacent second grinding units 44 for the subsequent separation of the material.

Referring to FIG. 11, in some embodiments, the ceramic grinding member 4 can include a first grinding member 41 and a second grinding member 42, and the hardness of the first grinding member 41 is greater than the hardness of the second grinding member 42. The first grinding member 41 and the second grinding member 42 are alternately stacked on the same support member 1 along the axial direction of the support member 1, so as to meet the hardness requirements of the grinding device 200 for the ceramic grinding member 4, and at the same time, reduce the manufacturing cost of the ceramic grinding member 4 and the ceramic grinding assembly 100.

Taking the first grinding member 41 using silicon nitride as an example, the second grinding member 42 can adopt zirconia or other ceramic materials with a hardness smaller than silicon nitride. The ceramic material for preparing the first grinding member 41 and the second grinding member 42 is not further limited in the present application.

A grinding protrusion 411 is disposed at a peripheral direction of the first grinding member 41, and protrudes from an exterior of the second grinding member 42, so that when the support member 1 rotates, the support member 1 can drive the grinding protrusion 411 to rotate synchronously and the material can be ground by the grinding protrusion 411. The grinding protrusion 411 can be a trapezoidal protrusion, with a top of the trapezoidal protrusion protruding from the exterior of the second grinding member 42, so that the direction of the force applied to the material can be changed during grinding, allowing the material in the grinding chamber of the grinding device 200 to form a stable turbulent flow.

In addition, the first grinding member 41 and the second grinding member 42 are alternately stacked on the same support member 1, so that multiple first grinding members 41 are provided at intervals on the same support member 1 along the axial direction of the support member 1, to reduce the resistance exerted by the grinding protrusion 411 to the material during grinding, thereby facilitating the circulation of the material between adjacent grinding protrusions 411.

An elastic gasket (not shown) is provided between the first grinding member 41 and the second grinding member 42, and the support member 1 is threaded through the elastic gasket, so that the first grinding member 41 and the second grinding member 42, which are adjacent, are isolated by the elastic gasket. This avoids hard collision between the first grinding member 41 and the second grinding member 42. At the same time, when the first pressing base 3 and the second pressing base 5 press on the ceramic grinding member 4, arranging the elastic gasket can further prevent the ceramic grinding members 4 on the same support member 1 from bearing excessive pressure when pressed by the first pressing base body 31 and the second pressing base 5, resulting in a state where the first grinding member 41 and the second grinding member 42 are both under pressure and not under pressure.

It should be noted that, in other embodiments, the first grinding member 41 and the second grinding member 42 may also be made of a ceramic material with the same hardness.

Referring to FIG. 6, the ceramic grinding assembly 100 may further include a limit sleeve 6, which is sleeved along a peripheral direction of the connecting base 2. Exemplarily, the limit sleeve 6 can be sleeved along a peripheral direction of the base body 211 of the first base body 21. A limit notch is provided at a position corresponding to each support member 1 at a peripheral direction of the limit sleeve 6. The support member 1 is threaded through the limit notch, and the first grinding unit 43 is clamped in the limit notch, so that the first grinding unit 43 can be clamped and fixed in the limit notch under the action of the support member 1. In addition, the first grinding member 41 and the second grinding member 42 in the first grinding unit 43 are limited by the limit notch to prevent the ceramic grinding member 4 from deviating relative to the support member 1 during the rotation of the support member 1.

It should be noted that FIG. 6 shows the structure of the limit sleeve 6 with six limit notches, which does not constitute a limitation to the structure of the limit sleeve 6. When the quantity of the support members 1 is changed, the quantity of the limit sleeves 6 is also changed.

Referring to FIG. 4, the ceramic grinding assembly 100 may further include a plurality of limit rods 7, and each ceramic grinding member 4 in the second grinding unit 44 is provided with a limit hole (not shown). The limit rod 7 is successively threaded through the limit hole of each ceramic grinding member 4, and is connected between the first pressing base 3 and the second pressing base 5. Through the cooperation between the limit rod 7 and the limit hole, the first grinding member 41 and the second grinding member 42 in the second grinding unit 44 are restricted from shifting relative to the support member 1 during grinding.

Specifically, one end of the limit rod 7 can be threaded through first pressing base 3 and respectively connected to at least part of the structure of the first pressing base 3 by a fastener or an interference fit. Similarly, the other end of the limit rod 7 can also be threaded through the second pressing base 5, and can be connected respectively to at least part of the structure of the second pressing base 5 by a fastener or an interference fit. The connection manners between the limit rod 7 and the first pressing base 3 as well as between the limit rod 7 and the second pressing base 5 are not further limited in the present application.

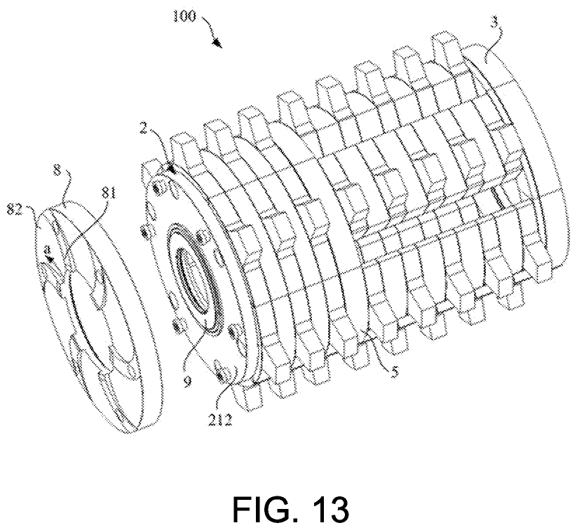

Referring to FIG. 13 and in combination with FIG. 2, the ceramic grinding assembly 100 may further include a turbine disk 8. A side of the turbine disk 8 facing the connecting base 2 is provided with a mounting groove, and the turbine disk 8 is constructed to be sleeved on the grinding shaft 210. Partial structure of the connection base 2 is provided within the mounting groove and is detachably connected to the turbine disk 8. Specifically, the fixing part 212 of the first base body 21 can be provided in the mounting groove. In this way, the turbine disk 8 is assembled on the connecting base 2 while enabling the material at the grinding shaft 210 of the grinding device 200 to be thrown to the exterior of the turbine disk 8 as the turbine disk 8 rotates with the grinding shaft 210, so as to prevent the material from accumulating at the grinding shaft 210 or the turbine disk 8.

A side of the turbine disk 8 away from the connecting base 2 is provided with a plurality of arc-shaped protrusions 81, and the plurality of arc-shaped protrusions 81 are evenly disposed along a peripheral direction of the turbine disk 8, and a channel 82 for throwing the material out is formed between two adjacent arc-shaped protrusions 81. A width of the channel 82 on its side facing the center of the turbine disk 8 is greater than a width of the channel 82 on its side away from the center of the turbine disk 8, so that when the turbine disk 8 rotates with the grinding shaft 210, the material can move within the channel 82 under the action of centrifugal force and is thrown to the exterior of the turbine disk 8.

Referring to FIG. 13, in some embodiments, a height of the arc-shaped protrusion 81 on its side facing the center of the turbine disk 8 is greater than a height of the arc-shaped protrusion 81 on its side away from the center of the turbine disk 8, so that when the material moves in the direction a in the channel 82, the pressure that can be applied to the material by the turbine disk 8 gradually decreases, allowing the kinetic energy of the material to increase gradually.

It should be noted that in some other embodiments, the height of the arc-shaped protrusion 81 on its side facing the center of the turbine disk 8 may also be equal to the height of the arc-shaped protrusion 81 on its side away from the center of the turbine disk 8. The height of the arc-shaped protrusion 81 is not further limited in the present application.

It should be noted that a seal ring 9 can be further provided in the turbine disk 8, and a part of the seal ring 9 can be disposed in the fixing part 212, so that the seal ring 9 enables a sealed connection between the turbine disk 8 and the fixing part 212 after the turbine disk 8 and the fixing part 212 are connected.

In the above technical solutions, the ceramic grinding assembly 100 is provided with the connecting base 2, the support member 1 and the first pressing base 3. Since the plurality of support members 1 are provided between the connecting base 2 and the first pressing base 3, and are configured to connect the connecting base 2 and the first pressing base 3, the fixation of the support members 1 between the connecting base 2 and the first pressing base 3 is thereby achieved. In addition, the plurality of ceramic grinding members 4 are stacked on respective support members 1 along the axial direction of the support members 1 and are constructed to rotate synchronously with the connecting base 2 when the connecting base 2 rotates, so that the plurality of ceramic grinding members 4 rotate under the drive of the connecting base 2 and the support members 1, achieving the grinding function of the ceramic grinding assembly 100. Meanwhile, compared to the plastic grinding members in existing grinding devices, the ceramic grinding member 4 has higher hardness, which can meet the hardness requirements of the grinding device for the grinding members, so as to achieve better grinding of materials. And the ceramic grinding member 4 is assembled on the grinding shaft 210 via the support member 1 and the connecting base 2, avoiding the direct interference connection between the ceramic grinding member 4 and the grinding shaft 210. Meanwhile, when the grinding shaft 210 rotates, the power of the grinding shaft 210 is firstly indirectly transmitted to the plurality of support members 1 through the connecting base 2, and then the torque generated by the grinding shaft 210 is transmitted to the ceramic grinding members 4 through the plurality of support members 1, so as to achieve the synchronous rotation of the ceramic grinding members 4.

It should be understood from the description of the present application that the terms “center”, “longitudinal”, “transverse”, “length”, “width”, “thickness”, “up”, “down”, “front”, “back”, “left”, “right”, “vertical”, “horizontal”, “top”, “bottom”, “inside”, and “outside”, etc. for indicating orientation or position relationship are based on the orientation or position relationship shown in the accompanying drawings, and are only for the purpose of facilitating the description of the present application and simplifying the description, rather than indicating or implying that the device or element referred to must have a specific orientation, and should be constructed and operated in a specific orientation, which cannot be understood as a limitation on the present application.

It should be understood that, in the description of the present application, the terms “including”, “having” and any variations thereof, are intended to cover non-exclusive inclusion. For example, processes, methods, display structures, products or devices including a series of steps or units are not limited to those steps or units that are clearly listed, but can include other steps or units that are not clearly listed or inherent in these processes, methods, products or devices.

Unless otherwise specified and defined, the terms “installation”, “connection”, “connected”, “fixing”, etc. shall be interpreted in a broad sense. For example, it can be a fixed connection, or a detachable connection, or an integration; it can be directly connected or indirectly connected through intermediate media; or it can be a connection inside the two components or an interaction relationship between the two components. For those skilled in the art, the specific meanings of the above terms in the present application can be understood according to specific situations. Furthermore, the terms “first”, “second”, etc. are used for descriptive purposes only and are not interpreted as indicating or implying relative importance or as implicitly specifying the quantity of the technical features indicated.

It should be noted that: the above-mentioned embodiments are only used to illustrate, rather than to limit, the technical solutions of the present application. Although the present application is described in detail with reference to the above-mentioned embodiments, those skilled in the art should understand that: the technical solutions recited in the above-mentioned embodiments can still be amended, or part or all of the technical features therein can be replaced equivalently. However, such amendments or replacements do not make the essence of the corresponding technical solutions deviate from the scope of the technical solutions in the embodiments of the present application.

What is claimed is:

1. A stirring system for lithium iron phosphate slurry, comprising: a first feeding mechanism, a second feeding mechanism, a first stirring tank, a homogenization pump, a first demagnetizing machine, a second stirring tank, a driving pump, a second demagnetizing machine, a heat exchanger and a grinding device; wherein
a material outlet of the first feeding mechanism is connected to a first material inlet of the first stirring tank, a material outlet of the second feeding mechanism is connected to a second material inlet of the first stirring tank, a first material outlet of the first stirring tank is connected to a material inlet of the homogenization pump, a material outlet of the homogenization pump is connected to a material inlet of the first demagnetizing machine, and a material outlet of the first demagnetizing machine is connected to a third material inlet of the first stirring tank;
a second material outlet of the first stirring tank is connected to a first material inlet of the second stirring tank, a first material outlet of the second stirring tank is connected to a material inlet of the driving pump, a material outlet of the driving pump is connected to a material inlet of the second demagnetizing machine, a material outlet of the second demagnetizing machine is connected to a material inlet of the heat exchanger, a material outlet of the heat exchanger is connected to a material inlet of the grinding device, and a material outlet of the grinding device is connected to a second material inlet of the second stirring tank;
the first stirring tank is further in communication with a remote controller, wherein the remote controller is configured to send a first control command to the first stirring tank at a first time, the first control command being configured to control a stirring speed of the first stirring tank to be greater than a preset speed threshold; and the remote controller is configured to send a second control command to the first stirring tank at a second time, the second control command being configured to control the stirring speed of the first stirring tank to be less than or equal to the preset speed threshold; and the first time is earlier than the second time;
the grinding device comprises a device body and a ceramic grinding assembly, the device body comprises a grinding cylinder and a grinding shaft penetrating through the grinding cylinder, and the ceramic grinding assembly is provided within the grinding cylinder;
the ceramic grinding assembly comprises a support unit, a connecting base, a first pressing base and a plurality of ceramic grinding members, the connecting base is provided to be opposite to the first pressing base along an axial direction of the support unit, and the connecting base is constructed to be sleeved on the grinding shaft and to rotate synchronously with the grinding shaft; the support unit comprises a plurality of support members, and the plurality of support members are disposed between the connecting base and the first pressing base and configured to connect the connecting base and the first pressing base;
the plurality of ceramic grinding members are stacked on respective support members along the axial direction of the support member and are constructed to rotate synchronously with the connecting base when the connecting base rotates;
the ceramic grinding members are each provided with a through hole, and the support member is threaded through the through hole and elastically connected with a hole wall of the through hole;
the first pressing base comprises a first pressing base body and a first pressing unit, the first pressing unit comprises a ring-shaped first pressing sheet, and the first pressing sheet is located within the first pressing base body;
an end of each support member is threaded through the first pressing base body, the first pressing sheet has a first penetration hole with an adjustable hole size, and the end of the each support member is threaded into the first penetration hole and detachably connected to the first pressing sheet;
a first pressing hole is further provided in a peripheral direction of the first pressing sheet, and the first pressing unit further comprises a first pressing member, which is threaded through the first pressing hole to adjust a size of the first penetration hole during its screwing in the first pressing hole;
the first pressing sheet comprises a pressing body, a circumferential side wall of the pressing body is provided with a slot body at a position corresponding to the each support member, and the first pressing sheet is provided with an elastic cantilever elastically connected to the pressing body in the slot body;
the pressing body and the elastic cantilever are each provided with an avoidance notch at a position corresponding to the same support member, and two avoidance notches are enclosed to form the first penetration hole;
the elastic cantilever is provided with a first hole part, and the slot body is provided with a second hole part at a position corresponding to the first pressing hole;
the first hole part and the second hole part form the first pressing hole, the first pressing member is successively threaded through the first hole part and the second hole part, so as to adjust a distance between the elastic cantilever and the slot body during screwing of the first pressing member.

2. The stirring system for lithium iron phosphate slurry according to claim 1, wherein the connecting base comprises a first base body and a second base body; the first base body comprises a base-body and a fixing part, an end of the base-body away from the first pressing base has an assembly cavity, and the second base body is sleeved in the assembly cavity and is conically fitted with a cavity wall of the assembly cavity; the second base body is constructed to be sleeved on the grinding shaft to drive the first base body to rotate synchronously when the grinding shaft rotates; the fixing part is disposed around a peripheral direction of the base body and is connected to the base-body; and the plurality of support members are evenly disposed on the fixing part and are fixedly connected to the fixing part.

3. The stirring system for lithium iron phosphate slurry according to claim 2, wherein the second base body is a conical sleeve, and an inner wall of the end of the base-body away from the first pressing base has a ring-shaped protrusion, and an inner wall of the ring-shaped protrusion is enclosed to form the assembly cavity; an inner wall of the assembly cavity is a conical surface compatible with a shape of a circumferential outer wall of the second base body; and in a direction from the connecting base to the first pressing base, a radial size of the conical sleeve gradually decreases.

4. The stirring system for lithium iron phosphate slurry according to claim 3, wherein the circumferential outer wall of the second base body has at least two first half-holes, and the inner wall of the assembly cavity is provided with a second half-hole at a position corresponding to each first half-hole, and the second half-hole and the first half-hole are enclosed to form a connecting hole;
the connecting base further comprises a fastener, the fastener is threaded through the connecting hole, each first half-hole is a threaded hole, a hole wall of the second half-hole is a smooth surface, and a height difference exists between the first half-hole and the second half-hole on a side facing the fastener;
the circumferential outer wall of the second base body has a third half-hole, a hole wall of the third half-hole is a smooth surface, the inner wall of the assembly cavity is provided with a fourth half-hole at a position corresponding to the third half-hole, the fourth half-hole is a threaded hole, and the fourth half-hole and the third half-hole are enclosed to form a disassembly hole compatible with a structure of the fastener.

5. The stirring system for lithium iron phosphate slurry according to claim 1, wherein the ceramic grinding assembly further comprises a second pressing base sleeved on the each support member, the second pressing base being provided between the connecting base and the first pressing base and configured to press onto the connecting base and a part of the ceramic grinding member;
the second pressing base comprises a second pressing base body, a second pressing unit and a pressing cover, the second pressing unit comprises a ring-shaped second pressing sheet, and one side of the second pressing sheet is provided in the second pressing base body; the pressing cover is configured to press on other side of the second pressing sheet and is constructed to be detachably connected with the grinding shaft; the each support member is threaded through the second pressing base body and detachably connected to the second pressing sheet;
the second pressing sheet is provided with a second penetration hole with an adjustable hole size, and the each support member is threaded through the second penetration hole; a second pressing hole is further provided in a peripheral direction of the second pressing sheet, and the second pressing unit further comprises a second pressing member, which is threaded through the second pressing hole to regulate a size of the second penetration hole during its screwing in the second pressing hole.

6. The stirring system for lithium iron phosphate slurry according to claim 2, wherein the ceramic grinding assembly further comprises a second pressing base sleeved on the each support member, the second pressing base being provided between the connecting base and the first pressing base and configured to press onto the connecting base and a part of the ceramic grinding member;
the second pressing base comprises a second pressing base body, a second pressing unit and a pressing cover, the second pressing unit comprises a ring-shaped second pressing sheet, and one side of the second pressing sheet is provided in the second pressing base body; the pressing cover is configured to press on other side of the second pressing sheet and is constructed to be detachably connected with the grinding shaft; the each support member is threaded through the second pressing base body and detachably connected to the second pressing sheet;
the second pressing sheet is provided with a second penetration hole with an adjustable hole size, and the each support member is threaded through the second penetration hole; a second pressing hole is further provided in a peripheral direction of the second pressing sheet, and the second pressing unit further comprises a second pressing member, which is threaded through the second pressing hole to regulate a size of the second penetration hole during its screwing in the second pressing hole.

7. The stirring system for lithium iron phosphate slurry according to claim 3, wherein the ceramic grinding assembly further comprises a second pressing base sleeved on the each support member, the second pressing base being provided between the connecting base and the first pressing base and configured to press onto the connecting base and a part of the ceramic grinding member;
the second pressing base comprises a second pressing base body, a second pressing unit and a pressing cover, the second pressing unit comprises a ring-shaped second pressing sheet, and one side of the second pressing sheet is provided in the second pressing base body; the pressing cover is configured to press on other side of the second pressing sheet and is constructed to be detachably connected with the grinding shaft; the each support member is threaded through the second pressing base body and detachably connected to the second pressing sheet;
the second pressing sheet is provided with a second penetration hole with an adjustable hole size, and the each support member is threaded through the second penetration hole; a second pressing hole is further provided in a peripheral direction of the second pressing sheet, and the second pressing unit further comprises a second pressing member, which is threaded through the second pressing hole to regulate a size of the second penetration hole during its screwing in the second pressing hole.

8. The stirring system for lithium iron phosphate slurry according to claim 4, wherein the ceramic grinding assembly further comprises a second pressing base sleeved on the each support member, the second pressing base being provided between the connecting base and the first pressing base and configured to press onto the connecting base and a part of the ceramic grinding member;
the second pressing base comprises a second pressing base body, a second pressing unit and a pressing cover, the second pressing unit comprises a ring-shaped second pressing sheet, and one side of the second pressing sheet is provided in the second pressing base body; the pressing cover is configured to press on other side of the second pressing sheet and is constructed to be detachably connected with the grinding shaft; the each support member is threaded through the second pressing base body and detachably connected to the second pressing sheet;
the second pressing sheet is provided with a second penetration hole with an adjustable hole size, and the each support member is threaded through the second penetration hole; a second pressing hole is further provided in a peripheral direction of the second pressing sheet, and the second pressing unit further comprises a second pressing member, which is threaded through the second pressing hole to regulate a size of the second penetration hole during its screwing in the second pressing hole.

9. The stirring system for lithium iron phosphate slurry according to claim 5, wherein each of the plurality of ceramic grinding members stacked on the each support member comprises a first grinding unit and a second grinding unit, the first grinding unit being disposed between the second pressing base and the connecting base, and the second grinding unit being disposed between the second pressing base and the first pressing base; and a gap is provided between adjacent second grinding units for material circulation;
the ceramic grinding assembly further comprises a limit sleeve, which is sleeved in a peripheral direction of the connecting base, and a limit notch is provided at a position corresponding to the each support member in the peripheral direction of the limit sleeve;
the support member is threaded through the limit notch, and the first grinding unit is clamped in the limit notch;
the ceramic grinding assembly further comprises a plurality of limit rods, each ceramic grinding member of the second grinding unit is provided with a limit hole, and the limit rod is successively threaded through the limit hole of each ceramic grinding member and is connected between the first pressing base and the second pressing base.

10. The stirring system for lithium iron phosphate slurry according to claim 6, wherein each of the plurality of ceramic grinding members stacked on the each support member comprises a first grinding unit and a second grinding unit, the first grinding unit being disposed between the second pressing base and the connecting base, and the second grinding unit being disposed between the second pressing base and the first pressing base; and a gap is provided between adjacent second grinding units for material circulation;
the ceramic grinding assembly further comprises a limit sleeve, which is sleeved in a peripheral direction of the connecting base, and a limit notch is provided at a position corresponding to the each support member in the peripheral direction of the limit sleeve;
the support member is threaded through the limit notch, and the first grinding unit is clamped in the limit notch;
the ceramic grinding assembly further comprises a plurality of limit rods, each ceramic grinding member of the second grinding unit is provided with a limit hole, and the limit rod is successively threaded through the limit hole of each ceramic grinding member and is connected between the first pressing base and the second pressing base.

11. The stirring system for lithium iron phosphate slurry according to claim 7, wherein each of the plurality of ceramic grinding members stacked on the each support member comprises a first grinding unit and a second grinding unit, the first grinding unit being disposed between the second pressing base and the connecting base, and the second grinding unit being disposed between the second pressing base and the first pressing base; and a gap is provided between adjacent second grinding units for material circulation;
the ceramic grinding assembly further comprises a limit sleeve, which is sleeved in a peripheral direction of the connecting base, and a limit notch is provided at a position corresponding to the each support member in the peripheral direction of the limit sleeve;
the support member is threaded through the limit notch, and the first grinding unit is clamped in the limit notch;
the ceramic grinding assembly further comprises a plurality of limit rods, each ceramic grinding member of the second grinding unit is provided with a limit hole, and the limit rod is successively threaded through the limit hole of each ceramic grinding member and is connected between the first pressing base and the second pressing base.

12. The stirring system for lithium iron phosphate slurry according to claim 8, wherein each of the plurality of ceramic grinding members stacked on the each support member comprises a first grinding unit and a second grinding unit, the first grinding unit being disposed between the second pressing base and the connecting base, and the second grinding unit being disposed between the second pressing base and the first pressing base; and a gap is provided between adjacent second grinding units for material circulation;
the ceramic grinding assembly further comprises a limit sleeve, which is sleeved in a peripheral direction of the connecting base, and a limit notch is provided at a position corresponding to the each support member in the peripheral direction of the limit sleeve;
the support member is threaded through the limit notch, and the first grinding unit is clamped in the limit notch;
the ceramic grinding assembly further comprises a plurality of limit rods, each ceramic grinding member of the second grinding unit is provided with a limit hole, and the limit rod is successively threaded through the limit hole of each ceramic grinding member and is connected between the first pressing base and the second pressing base.

13. The stirring system for lithium iron phosphate slurry according to claim 1, wherein the ceramic grinding member comprises a first grinding member and a second grinding member, a hardness of the first grinding member is greater than a hardness of the second grinding member;
along the axial direction of the support member, the first grinding member and the second grinding member are alternately stacked on the same support member;
a grinding protrusion is provided in a periphery direction of the first grinding member and protrudes from a periphery edge of the second grinding member; and an elastic gasket is sandwiched between the first grinding member and the second grinding member.

14. The stirring system for lithium iron phosphate slurry according to claim 2, wherein the ceramic grinding member comprises a first grinding member and a second grinding member, a hardness of the first grinding member is greater than a hardness of the second grinding member;
along the axial direction of the support member, the first grinding member and the second grinding member are alternately stacked on the same support member;
a grinding protrusion is provided in a periphery direction of the first grinding member and protrudes from a periphery edge of the second grinding member; and an elastic gasket is sandwiched between the first grinding member and the second grinding member.

15. The stirring system for lithium iron phosphate slurry according to claim 3, wherein the ceramic grinding member comprises a first grinding member and a second grinding member, a hardness of the first grinding member is greater than a hardness of the second grinding member;
along the axial direction of the support member, the first grinding member and the second grinding member are alternately stacked on the same support member;
a grinding protrusion is provided in a periphery direction of the first grinding member and protrudes from a periphery edge of the second grinding member; and an elastic gasket is sandwiched between the first grinding member and the second grinding member.

16. The stirring system for lithium iron phosphate slurry according to claim 4, wherein the ceramic grinding member comprises a first grinding member and a second grinding member, a hardness of the first grinding member is greater than a hardness of the second grinding member;
along the axial direction of the support member, the first grinding member and the second grinding member are alternately stacked on the same support member;
a grinding protrusion is provided in a periphery direction of the first grinding member and protrudes from a periphery edge of the second grinding member; and an elastic gasket is sandwiched between the first grinding member and the second grinding member.
